(19) United States
(12) Patent Application Publication
(10) Pub. No.: US 2012/0129026 A1
(43) Pub. Date: May 24, 2012

(54) BATTERY PACK WITH A HEAT DISSIPATION STRUCTURE

(76) Inventor: Donald P.H. Wu, Hsinchu County (TW)

(21) Appl. No.: 12/950,084

(22) Filed: Nov. 19, 2010

(51) Int. Cl. H01M 2/10

(52) U.S. Cl. 429/99

(57) ABSTRACT

A battery pack with a heat dissipation structure comprises two battery modules, four heat dissipation elements, and four spacing sleeves that are combined by four screws. The four heat dissipation elements and the four spacing sleeves are disposed between the two battery modules. The dissipation elements are in direct contact with the respective battery modules, so that the heat of the respective battery module will be conducted to the heat dissipation plates then dissipated into the air through the heat dissipation fins of the heat dissipation plates. Between the two battery modules is formed a heat dissipation channel, which can avoid the heat accumulation due to direct contact of the two battery modules while allowing the hot air in the heat dissipation channel to be exchanged to the cool air outside the battery pack.

### BACKGROUND OF THE INVENTION

1. Field of the Invention

The present invention relates to a battery pack, and more particularly to a battery pack with a heat dissipation structure.

2. Description of the Prior Art

Referring to FIG. 1, a conventional battery pack 10 disclosed in U.S. Pub. No. 20070037051 comprises plural battery cells 11, and plural spacers 12 arranged between the respective battery cells 11. Each of the spacers 12 is formed with plural concavo-convex structures 13, so that plural air channels 14 will be formed after the respective battery cells 11 and the spacers 12 are assembled, facilitating the heat dissipation of the battery pack 10.

It is to be noted that, the heat dissipation structure of the above battery pack 10, which is formed by arranging one spacer between each two neighboring battery cells, has a bad heat dissipation effect for the following reasons:

1. After the assembly of the battery pack 10, the surface of the spacer 12, which is formed with the concavo-convex structure 13, covers one surface of the battery cell 11 and cannot be directly exposed, making the dissipation of the heat difficult.

2. After the assembly of the battery pack 10, the air channels 14 formed by the plural concavo-convex structures 13 are not in communication with each other, and an external opening of the respective air channels 14 is quite narrow, so that the air is difficult to circulate, leading to the accumulation of the heat.

The present invention has arisen to mitigate and/or obviate the afore-described disadvantages.

### SUMMARY OF THE INVENTION

The primary objective of the present invention is to provide a battery pack with a heat dissipation structure which comprises two battery modules spaced by a distance, avoiding the heat accumulation due to direct contact of the two battery modules, in addition between the two battery modules is formed a heat dissipation channel, allowing the hot air in the heat dissipation channel to be smoothly exchanged with the cool air outside the battery pack, cooling down the temperature.

The secondary objective of the present invention is to provide a battery pack with a heat dissipation structure in which heat dissipation fins are collectively disposed on the left surfaces and the right surfaces of the respective battery modules, not only avoiding the heat accumulation in the inner surface but also facilitating the space arrangement of the battery pack when in use, for example, the heat dissipation fins can be arranged toward a place with better ventilation.

### BRIEF DESCRIPTION OF THE DRAWINGS

FIG. 1 is a perspective view of a conventional battery pack;

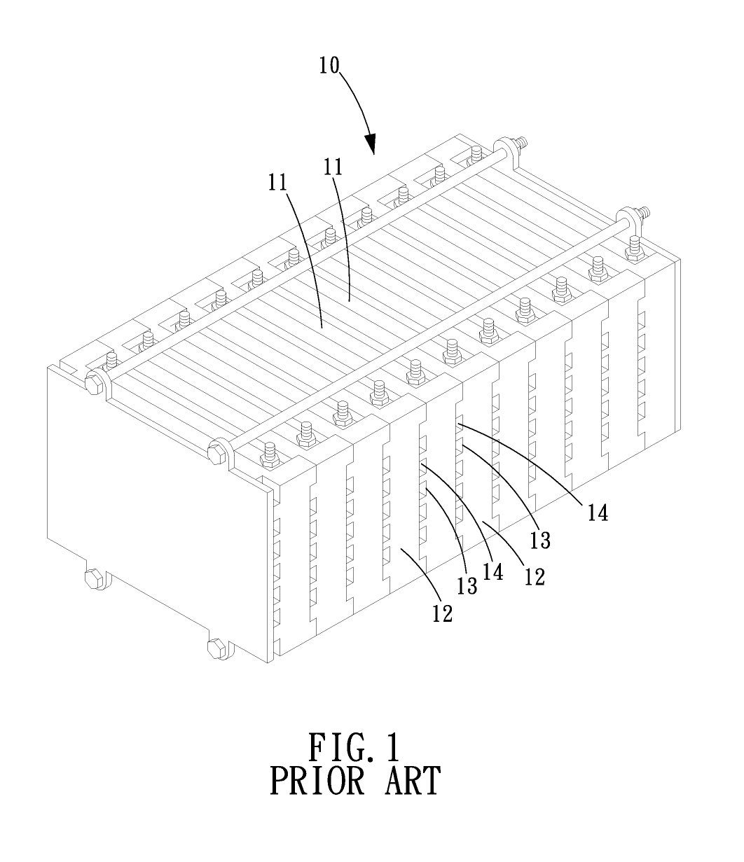

FIG. 2 is an exploded view of a battery pack with a heat dissipation structure in accordance with the present invention;

FIG. 3 is a combinational view of the battery pack with a heat dissipation structure in accordance with the present invention;

FIG. 4 is a cross-sectional view of FIG. 3 along the line A-A;

FIG. 5 is a side view of the battery pack with a heat dissipation structure in accordance with the present invention; and

FIG. 6 is a schematic view showing how the battery pack with a heat dissipation structure in accordance with the present invention is additionally provided with another two battery modules.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

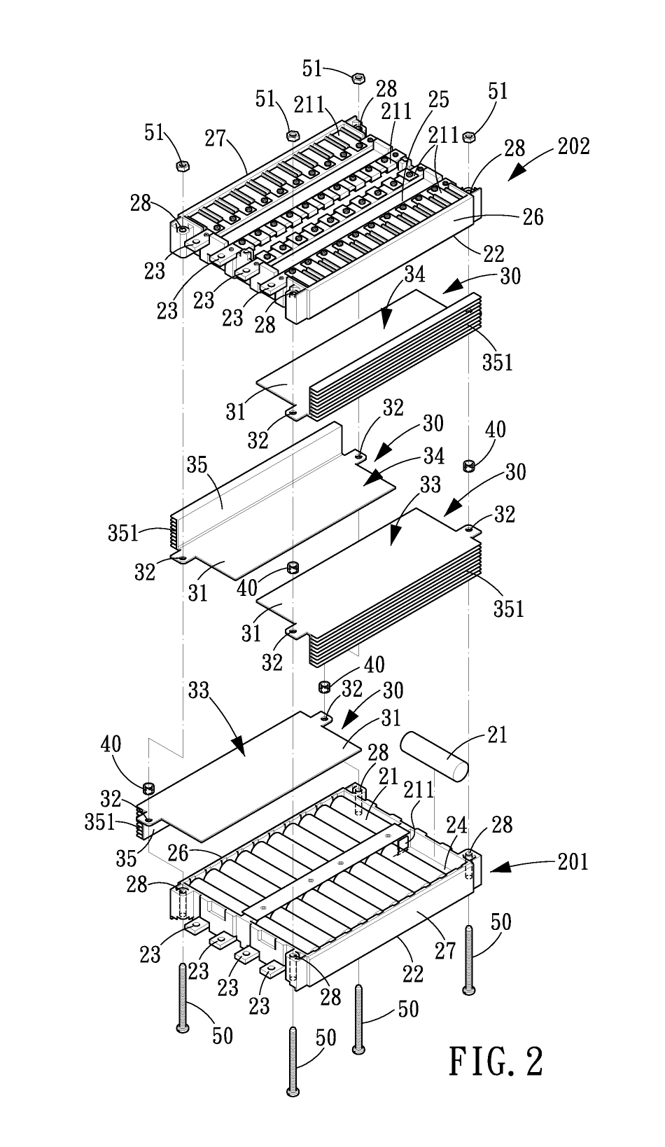

Referring to FIGS. 2-5, a battery pack with a heat dissipation structure in accordance with the present invention comprises two battery modules 201, 202, four heat dissipation elements 30, four spacing sleeves 40 that are combined by four screws 50, and the four heat dissipation elements 30 and the four spacing sleeves 40 are disposed between the two battery modules 201, 202.

Each of the battery modules 201, 202 includes plural battery cells 21 that are electrically connected through metal connecting strips 211 in a rectangular frame 22 and have common output terminals 23. The frame 22 includes an inner surface 24, an outer surface 25, a left surface 26 and a right surface 27. Each of the battery cells 21 has a side surface exposed out of the inner surface 24 of the frame 22. The frame 22 is further formed with a through hole 28 in each of four corners thereof.

Each of the heat dissipation elements 30 is made of metal and provided with a plane plate 31. The plane plate 31 is provided with a locking hole 32 at each of two opposite ends thereof. The plane plate 31 further includes a channel surface 33 and a contact surface 34 that are opposite each other. The contact surface 34 is provided with a heat dissipation plate 35 protruding therefrom. The heat dissipation plate 35 is formed with plural spaced fins 351 on an outer surface thereof. The contact surfaces 34 of the heat dissipation elements 30 are brought into contact with the side surfaces of the battery cells 21 exposed out of the inner surface 24 of the frame 22. The heat dissipation plates 35 are positioned against the left side surfaces 26 and the right side surfaces 27 of the battery modules 201, 202. The locking holes 32 of the heat dissipation elements 30 are aligned with the respective through holes 28 of the frame 22, so that each of the battery modules 201, 202 is provided with two heat dissipation elements 30 in a contact manner.

The spacing sleeves 40 are disposed in alignment with the respective locking holes 32 of the heat dissipation elements 30.

After being inserted through the through holes 28 of the battery module 201, the locking holes 32 of the heat dissipation element 30, the spacing sleeves 40, and the through holes 28 of the battery module 202 in order, the respective screws 50 will be screwed with a nut 51, so that the two channel surfaces 33 between the two battery modules 201, 202 are spaced by a distance, forming a heat dissipation channel 60.

The aforementioned is the summary of the positional and structural relationship of the respective components of the preferred embodiment in accordance with the present invention.

For a better understanding of the present invention, its operation and function, reference should be made to FIGS. 2-5:

The heat of the battery pack is released from the surfaces of the respective battery cells 21, and the contact surfaces 34 of the heat dissipation elements 30 are in direct contact with the side surfaces of the respective battery cells 21, so that the heat of the respective battery cells 21 is conducted to the heat dissipation plates 35 and then dissipated into the air through the heat dissipation fins 351 of the heat dissipation plates 35.

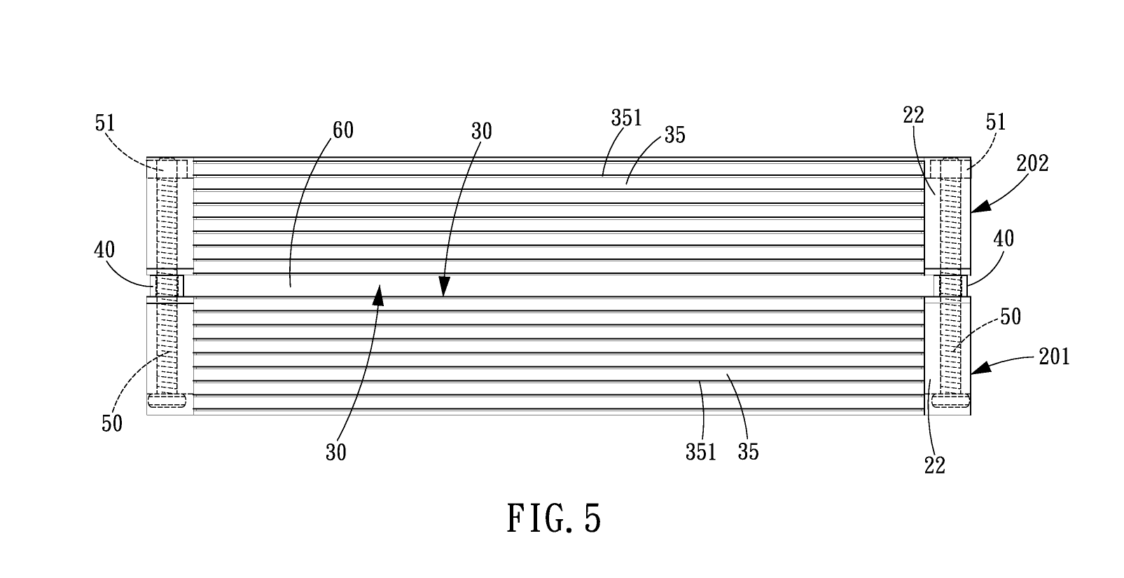

It is to be noted that, referring to FIG. 5, the two battery modules 201, 202 of the battery pack are spaced by the spacing sleeves 40, avoiding the heat accumulation due to direct contact between the two battery modules 201, 202. In addition, the heat dissipation channel 60 formed between the two battery modules 201, 202 allows the hot air in the heat dissipation channel 60 to be smoothly exchanged with the cool air outside the battery pack, cooling down the temperature.

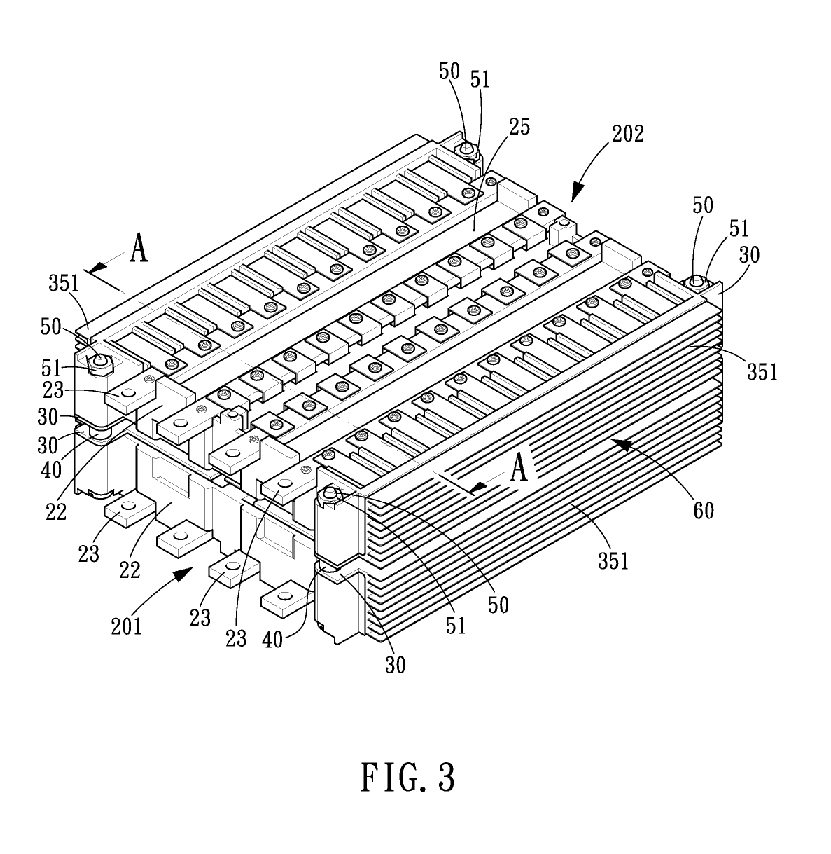

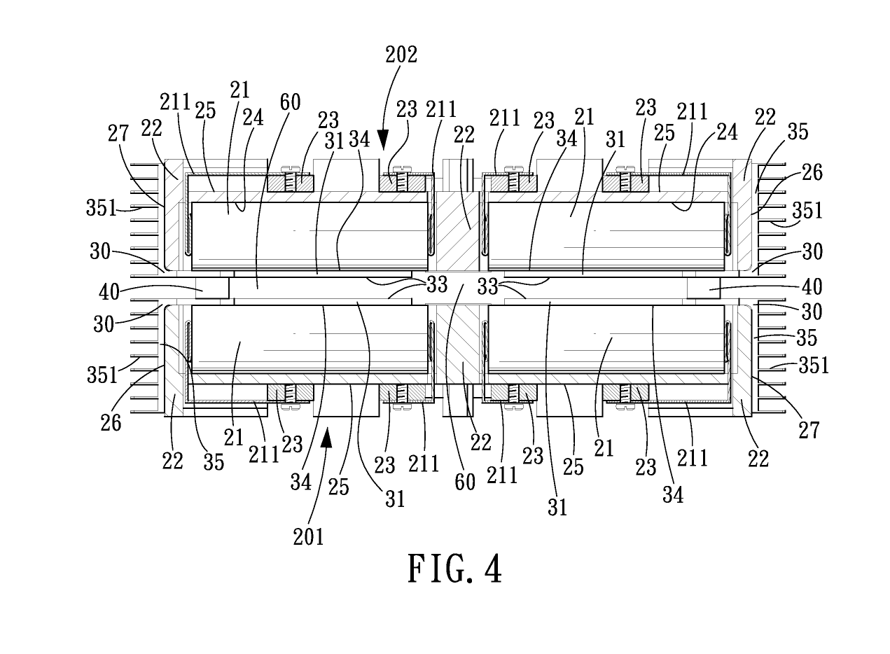

Furthermore, referring to FIGS. 3-4, the heat dissipation fins 351 of the battery pack are collectively disposed on the left surfaces 26 and the right surfaces 27, which not only avoids the heat accumulation in the inner surface 24 but also facilitates the space arrangement of the battery pack when in use, for example, the heat dissipation fins 351 can be arranged toward a place with better ventilation.

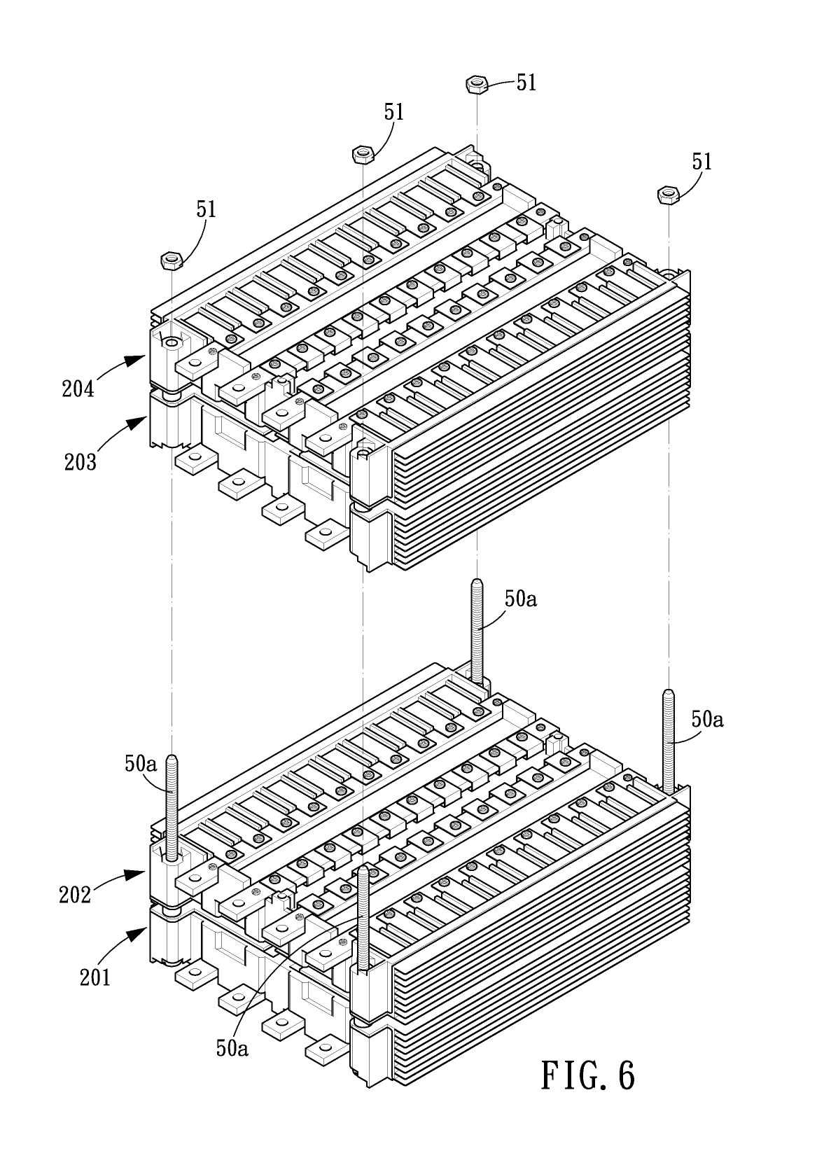

It is to be mentioned that, the battery pack of the present invention is formed by assembling two battery modules 201, 202 one upon another by screws, referring to FIG. 6, another two battery modules 203, 204 are additionally disposed at one side of a combination of the two battery modules 201, 202. At this moment, the four battery modules 201, 202, 203, 204 can be assembled by extra long screws 50a, in other words, the structure of the present invention is easy to extend.

While we have shown and described various embodiments in accordance with the present invention, it is clear to those skilled in the art that further embodiments may be made without departing from the scope of the present invention.

What is claimed is:

1. A battery pack with a heat dissipation structure comprising:
at least two battery modules each including plural battery cells that are electrically connected in a rectangular frame, the frame including an inner surface, an outer surface, a left surface and a right surface, each of the battery cells having a side surface exposed out of the inner surface of the frame, the frame being further formed with a through hole in each of four corners thereof;
at least four heat dissipation elements being made of metal and each provided with a plane plate, the plane plate being provided with a locking hole at each of two opposite ends thereof, the plane plate further including a channel surface and a contact surface that are opposite each other, the contact surface being provided with a heat dissipation plate protruding therefrom, the heat dissipation plate being formed with plural spaced fins on an outer surface thereof, the contact surfaces the heat dissipation elements being brought into contact with the side surfaces of the battery cells exposed out of the inner surface of the frame, the heat dissipation plates being positioned against the left side surfaces and the right side surfaces of the battery modules, the locking holes of the heat dissipation elements being aligned with the respective through holes of the frame, each of the battery modules being provided with two heat dissipation elements in a contact manner;
at least four spacing sleeves being disposed in alignment with the respective locking holes of the heat dissipation elements; and
at least four screws being inserted through the through holes of a first battery module of the at least two battery modules, the locking holes of the heat dissipation element, the spacing sleeves, and the through holes of a second battery module of the at least two battery module in order and then screwed with nuts, the two channel surfaces between the two battery modules being spaced by a distance, forming a heat dissipation channel.
